(19) United States
(12) Patent Application Publication
(10) Pub. No.: US 2026/0010714 A1
(43) Pub. Date: Jan. 8, 2026

(54) METHOD AND DEVICE FOR PARSING DATABASE QUERY STATEMENT, AND STORAGE MEDIUM

(71) Applicant: Beijing Volcano Engine Technology Co., Ltd., Beijing (CN)

(72) Inventors: Rong KANG, Beijing (CN); Linhui XU, Beijing (CN); Shuai WANG, Beijing (CN); Xianghong XU, Beijing (CN); Zhimin LIANG, Beijing (CN); Shangyu LUO, Los Angeles, CA (US); Tieying ZHANG, Los Angeles, CA (US); Jianjun CHEN, Los Angeles, CA (US); Rui SHI, Beijing (CN)

(21) Appl. No.: 19/173,637

(22) Filed: Apr. 8, 2025

(30) Foreign Application Priority Data
Jul. 4, 2024 (CN) 202410897308.4

(51) Int. Cl. G06F 40/211; G06F 16/2455

(52) U.S. Cl. CPC G06F 40/211; G06F 16/2455

(57) ABSTRACT

Provided are a method and device for parsing a database query statement, and a storage medium. A query statement for a database table to be queried is obtained, and an empty database table corresponding to the database table to be queried is created; the query statement is executed in the empty database table, and a parser installed in a database is called to parse the query statement to obtain a syntax tree, and an execution plan is generated based on the syntax tree for execution in the empty database table; and the syntax tree is obtained from the parser in an execution process of the query statement, and a syntax tree serialization result is generated and output as a parsing result of the query statement.

### CROSS-REFERENCE TO RELATED APPLICATION(S)

This application claims priority to Chinese Application No. 202410897308.4 filed on Jul. 4, 2024, the disclosure of which is incorporated herein by reference in its entirety.

### FIELD

Embodiments of the present disclosure relate to the technical fields of computers and network communications, and in particular, to a method and device for parsing a database query statement, and a storage medium.

### BACKGROUND

A database system is widely used in various industries, such as a MySQL database and OKthe like. Performance optimization of a databases is particularly important. In many directions of the performance optimization of the database (such as query statement rewriting and index recommendation and the like), query statement parsing is a first step that is essential.

Generally, the query statement parsing includes steps such as lexical parsing, syntax parsing, and semantic optimization. In the prior art, a third-party parser is often used to parse a query statement of a database, and then perform performance optimization on the database based on a parsing result.

However, the third-party parser in the prior art has low parsing coverage and low parsing accuracy and efficiency for various syntaxes of the database, and may not achieve semantic optimization.

### SUMMARY

Embodiments of the present disclosure provide a method and a device for parsing a database query statement, and a storage medium.

In a first aspect, the embodiments of the present disclosure provide a method for parsing a database query statement, and the method includes: obtaining a query statement for a database table to be queried, and creating an empty database table corresponding to the database table to be queried, the empty database table and the database table to be queried having a same structure; executing the query statement in the empty database table, calling a parser installed in a database to parse the query statement to obtain a syntax tree, and generating an execution plan based on the syntax tree for execution in the empty database table; and obtaining the syntax tree from the parser in an execution process of the query statement, and generating a syntax tree serialization result based on the syntax tree, as a parsing result of the query statement to be output.

In a second aspect, the embodiments of the present disclosure provide a device for parsing a database query statement, and the device includes: an obtaining unit configured to obtain a query statement for a database table to be queried; a creation unit configured to create an empty database table corresponding to the database table to be queried, the empty database table and the database table to be queried having a same structure; an execution unit configured to execute the query statement in the empty database table, call a parser installed in a database to parse the query statement to obtain a syntax tree, and generate an execution plan based on the syntax tree for execution in the empty database table; and a serialization unit configured to obtain the syntax tree from the parser in an execution process of the query statement, and generate a syntax tree serialization result based on the syntax tree, as a parsing result of the query statement to be output.

In a third aspect, the embodiments of the present disclosure provide an electronic device, the electronic device includes at least one processor and a memory, the memory stores computer-executable instructions; and the at least one processor is configured to execute the computer-executable instructions stored in the memory to cause the at least one processor to perform the method for parsing the database query statement in the first aspect and in various possible designs of the first aspect.

In a fourth aspect, the embodiments of the present disclosure provide a computer-readable storage medium. The computer-readable storage medium stores computer-executable instructions which, when executed by a processor, implement the method for parsing the database query statement in the first aspect and in various possible designs of the first aspect.

In a fifth aspect, the embodiments of the present disclosure provide a computer program product, including computer-executable instructions which, when executed by a processor, implement the method for parsing the database query statement in the first aspect and in various possible designs of the first aspect.

### BRIEF DESCRIPTION OF THE DRAWINGS

To describe the technical solutions in the embodiments of the present disclosure or in the prior art more clearly, the following briefly introduces the accompanying drawings for describing the embodiments or the prior art. Apparently, the accompanying drawings in the following description show merely some embodiments of the present disclosure, and a person of ordinary skill in the art may still derive other drawings from the accompanying drawings without creative efforts.

FIG. 1a is an example diagram of a detailed process of a parsing part for a database query statement according to an embodiment of the present disclosure;

FIG. 1b is an example diagram of an overall parsing procedure for a database query statement according to another embodiment of the present disclosure;

FIG. 2 is a flowchart of a method for parsing a database query statement according to an embodiment of the present disclosure;

FIG. 3 is a schematic diagram of traversing of a print approach in a MySQL database in the prior art;

FIG. 4 is a structural block diagram of a device for parsing a database query statement according to an embodiment of the present disclosure; and

FIG. 5 is a schematic diagram of a hardware structure of an electronic device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure are clearly described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

A database system is widely used in various industries, such as a MySQL database and the like. Performance optimization of a databases is particularly important. In many directions of the performance optimization of the database (such as query statement rewriting and index recommendation and the like), query statement parsing is a first step that is essential. For example, for an SQL query statement rewriting task, whether there are redundant and reducible conditional clauses in a query statement may be detected based on a parsing result. For another example, for an index recommendation task, which columns and conditions are included in a where clause in an SQL statement, which relational tables are included in a From clause, and the like may be recognized based on a parsing result.

Generally, the query statement parsing includes steps such as lexical parsing, syntax parsing, and semantic optimization. For example, a parsing process for an SQL statement may be as follows.

1) The lexical parsing is a first stage of SQL parsing, a main task of which is to decompose an input SQL character string into a series of tokens. These tokens are usually basic elements that make up the SQL statement, such as keywords, identifiers, operators, and literals (such as digits and character strings). For example, SELECT*FROM table WHERE id=123 may be decomposed into tokens such as SELECT, *, FROM, table, WHERE, id, =, and 123.

2) The syntax parsing is a second stage of SQL parsing, a main task of which is to construct a syntax structure using token information generated in the lexical parsing stage. The syntax structure is usually referred to as an abstract syntax tree (AST). Specifically, a parser attempts to make up a structured tree structure by using the token information. In this process, the parser needs to check whether an order and a combination of the tokens comply with an SQL syntax specification.

3) The semantic optimization is a third stage of SQL parsing, which involves optimizing an SQL query statement. This stage mainly focuses on understanding and improving the intent and logic of query, and is achieved through transformation of the AST. Typical semantic optimization includes: condition reduction, determination of column attributions (supplementing complete table information for columns used in queries, especially when a multi-table connection is involved, clearly specifying which table each column belongs to, so as to avoid ambiguity), adjustment of connection structure information (transforming a “multi-table connection representation mixed with USING/ON/WHERE” into a “multi-table connection representation with a uniform and standard form”, which is beneficial for downstream task recognition), and the like.

In the prior art, a third-party parser is often used to parse a query statement of a database, and then perform performance optimization on the database based on a parsing result. However, a syntax tree structure obtained by the third-party parser by parsing a database query statement should be kept being consistent with the parsing performed by the database during execution of the query statement. This not only requires correct parsing on the syntax tree (including recognition of queries, subqueries, keywords, and parameters included in the query statement), but also requires correct optimization and transformation on the syntax tree. Therefore, challenges that need to be solved by the parser include the followings.

1) Parsing coverage: a database query statement has a very complex syntax. For example, there are many subtle differences (referred to as dialect) in syntaxes of databases in different versions. However, it is very difficult for the third-party parser to 100% cover and support all syntaxes, and developers need to adaptively solve it, which is time-consuming and costly.

2) Semantic optimization: a semantic optimization capability is crucial for downstream tasks. For example, determining column attributions is a prerequisite for a subsequent optimization task. This requires that the parser has to combine a table schema to complete the determination. For another example, a MySQL database may perform transformation, optimization, and reduction on an SQL statement in the logic optimization stage. At present, most third-party parsers can achieve lexical parsing and syntax parsing, but may not have the semantic optimization capability, or the semantic optimization capability is often inferior to the semantic optimization capability of the database itself. Moreover, optimization rules of the third-party parsers may also be different from a semantic optimization rule of the database itself, resulting in inaccurate semantic optimization, and affecting and even misleading the subsequent index recommendation.

3) Support for many versions of the database: the database has different versions having significant differences. At present, the existing third-party parsers often do not support customized parsing on a plurality of versions.

In summary, the third-party parser in the prior art has low parsing coverage and low parsing accuracy and efficiency for various syntaxes of the database, and may not achieve semantic optimization.

In order to solve at least one of the technical problems in the prior art, the present disclosure provides a method for parsing the database query statement. The method includes: obtaining a query statement for a database table to be queried, and creating an empty database table corresponding to the database table to be queried, the empty database table and the database table to be queried having a same structure; executing the query statement in the empty database table, calling a parser installed in a database to parse the query statement to obtain a syntax tree, and generating an execution plan based on the syntax tree for execution in the empty database table; and obtaining the syntax tree from the parser in an execution process of the query statement, and generating a syntax tree serialization result based on the syntax tree, as a parsing result of the query statement to be output. In the embodiments of the present disclosure, for the database query statement, the parser installed in the database is used to output the syntax tree, and the syntax tree is then serialized to obtain a structured parsing result. Due to the use of the parsing capability of the database for the query statement itself and the consistency between the parsing result and the database, the efficiency and accuracy of the parsing process are improved, and a query statement for any syntax supported by the database can be correctly parsed, without a limitation imposed by the version of the database. Compared with a third-party parser, the method has higher parsing coverage and higher semantic optimization capability and accuracy.

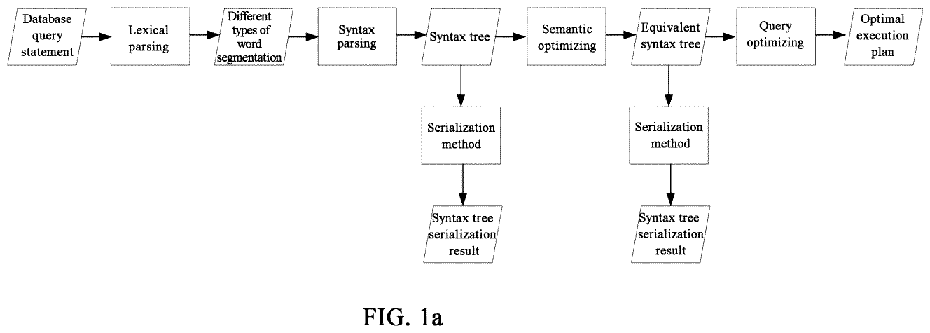

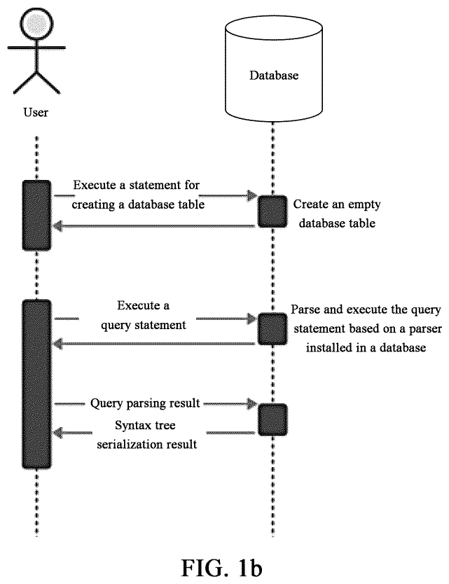

As shown in FIG. 1a, the method for parsing the database query statement provided in the present disclosure uses a parser installed in a database. A parsing process of a query statement mainly includes lexical parsing, syntax parsing, semantic optimization, and query optimization. The lexical parsing is to perform word segmentation on the query statement to obtain different types of word segmentation results. The syntax parsing is to construct a syntax tree based on the word segmentation result. The semantic optimization is to perform equivalent transformation based on the syntax tree to obtain an equivalent syntax tree. The query optimization is to generate an execution plan based on the equivalent syntax tree and select an optimal execution plan. The above parsing process is a capability of a parser installed in a database itself. However, the parser installed in the database may not output the syntax tree to a user after obtaining the syntax tree by parsing, but directly provides the syntax tree to subsequent processes for use. Therefore, the present disclosure has made modifications to the parser installed in the database, which adds a capability of outputting the syntax tree, serializing the output syntax tree, and generating a syntax tree serialization result for ease of understanding, so as to improve the compatibility. This is friendly to parsing and processing of downstream tasks and is beneficial for application for different purposes.

Based on the parser installed in the above database, the method for parsing the database query statement of the present disclosure is shown in FIG. 1b. For a query statement for a database table to be queried, an empty database table corresponding to the database table to be queried is first created, which can be triggered by a user by executing a statement for creating an empty database table. Then, the query statement is executed in the empty database table, the execution process is based on the parsing and execution by the above parser installed in the database, and a syntax tree serialization result is output as a parsing result corresponding to the query statement. Further, the user can query the parsing result.

It should be further noted that data (including but not limited to data for parsing, stored data, displayed data, and the like) acquired in the present disclosure are information and data which are authorized by the user or fully authorized by all parties. Furthermore, acquisition, use, and processing of relevant data all comply with relevant laws, regulations, and standards in relevant countries and districts, and corresponding operation entries are provided for the user for authorization or refuse selection.

The following will provide a detailed introduction to the method for parsing the database query statement in conjunction with specific embodiments.

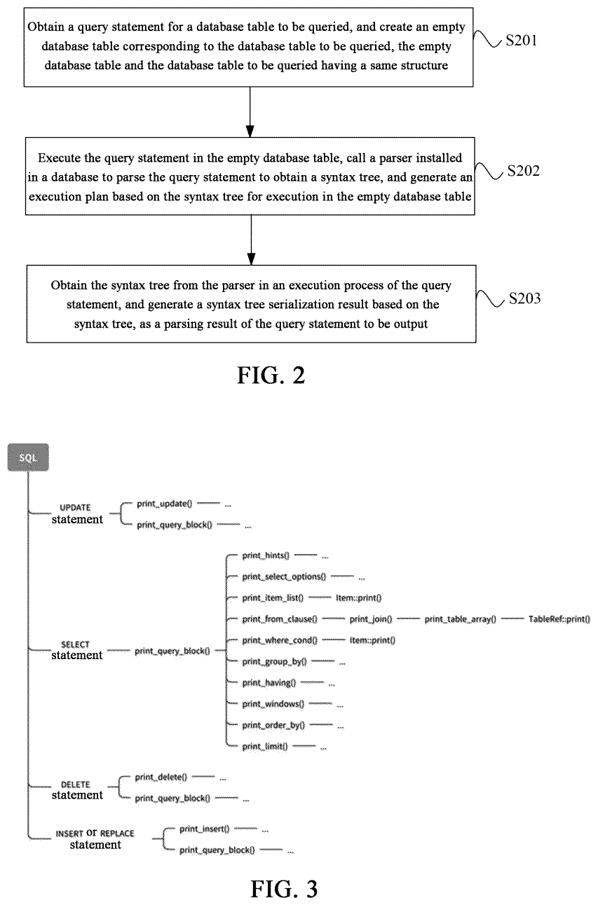

Referring to FIG. 2, FIG. 2 is a flowchart of a method for parsing a database query statement according to an embodiment of the present disclosure. The method of this embodiment can be applied to a terminal device or a server. The method for parsing the database query statement includes the followings.

At S201, a query statement for a database table to be queried is obtained, and an empty database table corresponding to the database table to be queried is created, and the empty database table and the database table to be queried have a same structure.

In this embodiment, in response to one or more query statements for a database needing to be parsed, the query statement may be obtained first. The query statement is a query statement for the database table to be queried. The database table to be queried can be a table of any type of database, such as a MySQL database, and the corresponding query statement is an SQL statement.

In this embodiment, the corresponding empty database table can be created for the database table to be queried. The empty database table and the database table to be queried have the same structure, including same numbers of columns and same column names, but the number of rows does not need to be considered. No data needs to be stored in the empty database table. The empty database table is used for executing the query statement in the following S202. In this embodiment, the query statement is executed not based on the database table to be queried, but based on the empty database table. There may be a large amount of data stored in the database table to be queried. Execution of the query statement based on the database table to be queried may take a long time and may not be secure, with a risk. In a case that the query statement is executed in the empty database table, although a return result is empty, the execution process is the same, the execution time is relatively short, and the security is high.

At S202, the query statement is executed in the empty database table, a parser installed in a database is called to parse the query statement to obtain a syntax tree, and an execution plan is generated based on the syntax tree for execution in the empty database table.

In this embodiment, the query statement is executed in the empty database table. In the execution process, the parser installed in the database is used to parse the query statement to obtain an abstract syntax tree (AST) which may also be referred to as a syntax tree, and the execution plan is generated based on the syntax tree, and the generated execution plan is executed in the empty database table. The parser installed in the database is also a built-in parser of the database, rather than a third-party parser. For example, for the MySQL database, an SQL parser of the MySQL database is used to parse the query statement. The parsing process in this embodiment is the same as the conventional parsing process, which includes lexical parsing, syntax parsing, semantic optimization, and the like for the query statement. A syntax tree can be obtained after the syntax parsing. The semantic optimization is to optimize the syntax tree obtained after the syntax parsing, to obtain an equivalent syntax tree. The capability of the semantic optimization is a data processing capability of the database itself, and an optimization rule completely uses an optimization rule of the database itself, including but not limited to, database table information completion, query condition reduction, connection structure optimization, and the like.

At S203, the syntax tree is obtained from the parser in an execution process of the query statement, and a syntax tree serialization result is generated based on the syntax tree, as a parsing result of the query statement to be output.

In this embodiment, the parser installed in the database usually does not output the syntax tree corresponding to the query statement, but directly generates the execution plan based on the syntax tree and executes the execution plan. In this embodiment, in order to obtain the syntax tree corresponding to the query statement, the parser installed in the database can be modified to output the syntax tree corresponding to the query statement. For example, a preset event tracker can be deployed in the parser installed in the database (i.e., a program code for acquiring a syntax tree is added to a specific position in a program code of the parser installed in the database), and the parser installed in the database can obtain the syntax tree after parsing the query statement. Certainly, the syntax tree can be obtained in other ways. It is relatively easy for some open source databases to obtain a syntax tree.

Optionally, in the parsing process, a syntax tree can be obtained after the syntax parsing, and an equivalent syntax tree can be obtained after the semantic optimization, so that a first preset event tracker can be deployed in the parser installed in the database in the syntax parsing process (i.e., the program code for acquiring the syntax tree can be added behind a program code with a syntax parsing function in the parser installed in the database). A first syntax tree obtained by syntax parsing the query statement by the parser can be obtained based on the first preset event tracker; and/or, a second preset event tracker can be deployed in the parser installed in the database in the semantic optimization process (i.e., the program code for acquiring the syntax tree can be added behind a program code with a semantic optimization function in the parser installed in the database). A second syntax tree obtained by semantic optimizing the query statement by the parser can be obtained based on the second preset event tracker. A difference between the syntax trees at different stages lies in whether they have been optimized, such as constant transmission, equivalence transmission, removal of useless conditions, and the like.

Further, after the syntax tree corresponding to the query statement is obtained, the syntax tree corresponding to the query statement can be serialized to generate the syntax tree serialization result. The syntax tree serialization result is in the form of a character string, i.e., serialization process is to represent the syntax tree in the form of the character string.

Optionally, the syntax tree corresponding to the query statement can be represented by a JSON character string. The JSON character string is platform-independent, flexible in data structure, easy to understand, and convenient for data exchange. It can provide good compatibility in various platforms and programming languages, not only supporting complex list and property structures, but also greatly simplifying serialization and deserialization. This character string is friendly to parsing and processing of downstream tasks, and is conducive to application for different purposes.

Further, in this embodiment, the syntax tree serialization result obtained above is used as the parsing result corresponding to the query statement, and is output, for subsequent use of the parsing result corresponding to the query statement.

In an optional embodiment, the syntax tree serialization result can be saved as a file, and an access path of the file can be obtained. A user can download the file by remote access. Downloading the file by remote access is relatively simple, but it requires a login permission and file copying permission of the database. However, file copying may have a risk.

In another optional embodiment, the syntax tree serialization result can be stored in an optimizer trace table corresponding to the query statement. The optimizer trace table is a system table of the database designed to generate human and program readable outputs that can help understand decisions made and operations performed by an optimizer. For example, for the MySQL database, the optimizer trace table, also known as an OPTIMIZER_TRACE table, can help understand decisions made and operations performed by a MySQL optimizer. Therefore, storing the syntax tree serialization result in the optimizer trace table is convenient for a user to view and eliminates traditional additional file storage and transmission requirements. Optionally, the syntax tree serialization results can be stored in trace information of the optimizer trace table corresponding to the query statement, or of course in any other position of the optimizer trace table.

In practical implementation, an optimizer trace table is generated for each query statement. The optimizer trace table contains detailed information about decisions made and operations performed by the query statement during query processing. An optimizer trace table corresponding to a subsequent query statement usually covers an optimizer trace table corresponding to a current query statement. Therefore, the optimizer trace table corresponding to the current query statement can be queried before generating the optimizer trace table for the subsequent query statement.

During querying, the optimizer trace table corresponding to the query statement can be displayed in response to a view instruction (i.e. a show-trace instruction, which is a standard query statement) for the optimizer trace table. Thus, the syntax tree serialization result can be obtained from the optimizer trace table corresponding to the query statement and output. In this embodiment, the user can access a parsing result through a standard query statement, which improves the practicality and the operability.

Optionally, the syntax tree serialization result may be stored into the optimizer trace table corresponding to the query statement in a form of key-value pair. A key in the key-value pair is identification information of the syntax tree serialization result, which is used for identifying the syntax tree serialization result, or used for distinguishing the syntax tree serialization results corresponding to the first syntax tree and the second syntax tree at different stages. A value in the key-value pair is the syntax tree serialization result. The syntax tree serialization results at different stages can be used for reflecting a logical optimization characteristic of the database. Further, during the querying, the syntax tree serialization result can be obtained from the optimizer trace table corresponding to the query statement based on the key, and is output as the parsing result corresponding to the query statement.

Certainly, in this embodiment, the syntax tree serialization result can also be stored into other system tables of the database, and examples will not be provided here one by one.

Further, the parsing result corresponding to the query statement can be used for different purposes, such as optimizing the database table to be queried. In one optimization, index recommendations can be made for the database table, i.e., a column needing to be queried can be determined based on the parsing result, and an index can be created for the queried column. Subsequently, a query can be made based on the indexes to increase the query speed. For another example, the query statement is optimized based on the parsing result. Certainly, other optimizations can also be performed based on the parsing result, and examples will not be provided here one by one.

According to the method for parsing the database query statement provided in the embodiments of the present disclosure, the method includes: obtaining a query statement for a database table to be queried, and creating an empty database table corresponding to the database table to be queried, the empty database table and the database table to be queried having a same structure; executing the query statement in the empty database table, calling a parser installed in a database to parse the query statement to obtain a syntax tree, and generating an execution plan based on the syntax tree for execution in the empty database table; and obtaining the syntax tree from the parser in the execution process of the query statement, and generating a syntax tree serialization result based on the syntax tree, as a parsing result of the query statement to be output. In the embodiments, for the database query statement, the parser installed in the database is used to output the syntax tree, and the syntax tree is then serialized to obtain a structured parsing result. Due to the use of the parsing capability of the database for the query statement itself and the consistency between the parsing result and the database, the efficiency and accuracy of the parsing process are improved, and a query statement for any syntax supported by the database can be correctly parsed, without a limitation imposed by the version of the database. Compared with a third-party parser, the method has higher parsing coverage and higher semantic optimization capability and accuracy.

Based on any one of the above embodiments, the syntax tree serialization result being generated based on the syntax tree in S203 may specifically include the followings.

At S2031, nodes in the syntax tree are traversed, and a structural body of a preset data structure corresponding to each of the nodes is generated in sequence, to obtain a tree structure corresponding to the syntax tree and based on the structural body. The structural body of the preset data structure includes a node type, property information, and sub-node information.

At S2032, the tree structure is transformed into a character string to obtain the syntax tree serialization result.

In this embodiment, a structural body of a preset data structure is designed to record relevant information of the nodes in the syntax tree. The structural body of the preset data structure includes but not limited to the node type, the property information, and the sub-node information.

Optionally, the structural body of the preset data structure may be JSONItem class object. Each JSONItem class object has three fields:
item_type: it represents type, describing a type of a current object (node) in the database;
properties: it represents a key-value pair composed of character strings, where the key is an property identification (such as name) and the value is specific property information of the current object, describing property information of the current object, which is property information that is paid attention to during in the parsing process, such as a name, a full name, a column name, a column type, a memory address, a database to which it belongs, a table of the current object; and
data: it represents a list of JSONItems, describing sub-object information contained in the current object.

JSONItem can represent various types of objects in the syntax tree in a compatible manner and depict hierarchical relationships among the objects.

In addition, JSONItem can provide three approaches:
create_data: an input is a type value, adds a sub-object into data of a current object and returns a memory address pointing to the sub-object;
add_properties: an input is a key and a value in the form of character string, and adds desired properties into properties of the current object; and
to_json: it covnerts a current object into a JSON character string representation for future storage in further storage manner.

Creation of a JSONItem class object can be achieved through the approaches of creat_data and add_properties. By the approach of to_json, it is possible to transform the current object into the JSON string representation.

In this embodiment, each of the nodes in the syntax tree can be respectively represented as the structural body of the corresponding preset data structure, and hierarchical structures of the syntax tree are still maintained among the structural bodies, thus forming a structural body based tree structure corresponding to the syntax tree. Compared with the syntax tree, the tree structure is easier to understand and can be easily serialized into a character string. Its serialization result is also easier to understand and has good compatibility, which is conducive to application in different purposes.

In practical implementation, the nodes in the syntax tree being traversed, and the structural body of the preset data structure corresponding to each of the nodes being generated in sequence, to obtain the tree structure corresponding to the syntax tree and based on the structural body, in S2031, may specifically include the followings.

The nodes in the syntax tree are traversed; preset functions are called in sequence, to extract the corresponding node type, the property information, and the sub-node information corresponding to each of the nodes; and the node type, the property information; and the sub-node information corresponding to each of the nodes are added into one preset data structure to generate the structural body of the corresponding preset data structure.

In this embodiment, each of the hierarchical nodes in the syntax tree can be traversed in sequence. In the traversing process, for each of the nodes, the node type, the property information, and the sub-node information of the node can be extracted and added into a preset data structure to generate a corresponding data structural body. The processes of traversing, extraction of the node information, and generation of the data structural body may refer to a mechanism of a print approach in the MySQL database for implementation.

As a reference, there is an execution process (hereinafter referred to as MySQL_AST_to_SQL) for concatenating the syntax tree into an SQL statement character string in the MySQL database. In this process, all the nodes, which have appeared in the SQL statement, in the syntax tree may be traversed, and key information related to the nodes may be transformed into a character string. The principle is the MySQL database itself provides a print approach for various types of syntax tree nodes. In the print approach, print approaches of sub-nodes can be further called to complete outputting of content to which the nodes belong. As shown in FIG. 3, in different types of SQL statements, their sub-nodes are also different. After the print approach of the outer layer is called, the print approach of each of the sub-nodes may be called in sequence. Taking the print approach of the most common SELECT statement as an example, after print_query-block( ) is called, the print approaches of sub-nodes such as print_cints( ) print_delect_options( ) and print_item_ist( ) may be called in sequence. In the approach of sub-node print_where_cond( ) the print approach of each conditional ITEM will be further called, and so on, until a node of an underlying type is traversed, such as an ITEM type or a TableRef type. The print approaches for UPDATE statement, DELETE statement, INSERT statement, or REPLACE statement are similar to that of SELECT statement and will not be elaborated here.

Based on the mechanism of the print approach in the MySQL database, in this embodiment, traversing logic of the syntax tree by the print approach is reused, and the called print approach of the sub-node is replaced by a approach for generating the structural body of the corresponding preset data structure. For example, a preset function can be defined as a to_json_xxx( ) approach. Taking the SELECT statement in the above example as an example, after to_json_query_block( ) is called, the to_json approaches of nodes such as to_json_hints( ) to_json_select_options( ) and to_json_item_list( ) may be called in sequence. In the approach of sub-node to_json_where_cond( ) the to_json approach of each ITEM may be further called. In the approach of each to_json_xxx( ) the node type, the property information, and the sub-node information can be extracted for the corresponding node, and can be added into one preset data structure (through the create_data approach and the add_properties approach in the above example) to generate the structural body of the corresponding preset data structure, i.e., the approach of each to_json_xxx( ) can return the structural body of the preset data structure of the corresponding node, such as the above JSONItem class object. The structural body-based tree structure is finally constructed.

This embodiment accurately replicates the hierarchical structure of the syntax tree through the structural body-based tree structure, making it easier to understand. Furthermore, based on the property structure of the structural body, in addition to the information used in the query statement, more additional but useful hidden information can be further extracted, such as JOIN type, column attribution information, and UNION type, and the like. Compared with the complexity of properties and functions in the syntax tree, this embodiment uses the structural body-based tree structure to represent the syntax tree, which is easier to understand, improves the parsing efficiency, and ensures the correctness and completeness of the parsing result.

Further, the tree structure is transformed into the character string to obtain the syntax tree serialization result. Optionally, the structural body in the whole tree structure can be transformed into JSON character strings using the to_json( ) approach of the outermost root node.

Based on any one of the above embodiments, in a case that the syntax tree serialization result is stored into the optimizer trace table corresponding to the query statement, a function of recording the optimizer trace table can be enabled before the execution of the query statement in the empty database table, so that an optimizer trace table can be generated during the execution of the query statement. Subsequently, the syntax tree serialization result corresponding to the query statement can be stored into the optimizer trace table corresponding to the query statement.

In addition, in response to a plurality of query statements existing, the optimizer trace table corresponding to the previous query statement may be covered by the optimizer trace table corresponding to the next query statement. Therefore, after the execution of a query statement is completed, the syntax tree serialization result corresponding to the query statement is obtained from the optimizer trace table corresponding to the query statement and is output, and whether other query statement to be executed is determined exists. In response to other query statement to be executed existing, a next query statement will continue to be executed. In response to no other query statement to be executed existing, the above process can be ended. Optionally, in response to no other query statement to be executed existing, the function of recording the optimizer trace table can be disabled.

Based on any one of the above embodiments, although the query statement is parsed using the parser installed in the database, the parser installed in the database does not have the capability of outputting a syntax tree. Therefore, the above embodiments actually modify the parser installed in the database, and the capability of outputting a syntax tree is added into the parser installed in the database. In addition, a capability of generating a syntax tree serialization result based on a syntax tree and a capability of storing and outputting the syntax tree serialization result are further added. Therefore, a preset database instance can be created, and the above capabilities are embedded into the preset database instance. In other words, the logic of outputting the syntax tree, the logic of serialize the syntax tree, the logic of outputting the parsing result, and the like in the above embodiments are integrated into a source code of the database for recompilation into a highly customized database mirror image (i.e. the preset database instance). Further, during creation of the empty database table corresponding to the database table to be queried, the empty database table corresponding to the database table to be queried can be created in the preset database instance, and thus, the query statement is executed in the empty database table of the preset database instance. The syntax tree is obtained from the parser in the preset database instance, and the syntax tree serialization result is generated and output. The preset database instance and a database instance where the database table to be queried is located are different database instances, so that it may not affect normal operation of the original database table to be queried and may not affect the security of the original table.

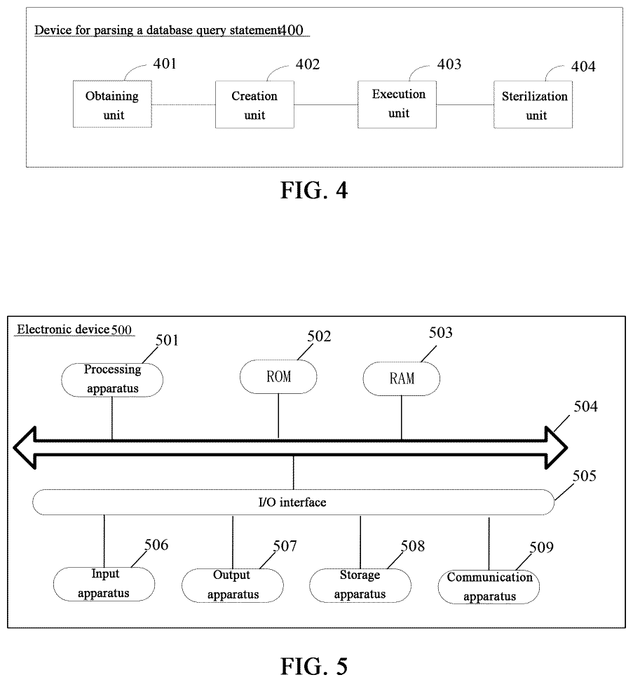

Corresponding to the approach for parsing the database query statement in the above embodiment, FIG. 4 is a structural block diagram of a device for parsing a database query statement according to an embodiment of the present disclosure. For ease of explanation, only parts related to the embodiments of the present disclosure are shown. Referring to FIG. 4, the device 400 for parsing the database query statement includes: an obtaining unit 401, a creation unit 402, an execution unit 403 and a serialization unit 404.

The obtaining unit 401 is configured to obtain a query statement for a database table to be queried.

The creation unit 402 is configured to create an empty database table corresponding to the database table to be queried, and the empty database table and the database table to be queried have a same structure.

The execution unit 403 is configured to execute the query statement in the empty database table, call a parser installed in a database to parse the query statement to obtain a syntax tree, and generate an execution plan based on the syntax tree for execution in the empty database table.

The serialization unit 404 is configured to obtain the syntax tree from the parser in an execution process of the query statement, and generate a syntax tree serialization result based on the syntax tree, as a parsing result of the query statement to be output.

In one or more embodiments of the present disclosure, to obtain the syntax tree from the parser in the execution process of the query statement, the execution unit 403 is configured to obtain, based on a preset event tracker in the parser, the syntax tree after the syntax tree is obtained by the parsing the query statement by the parser.

In one or more embodiments of the present disclosure, to obtain, based on the preset event tracker in the parser, the syntax tree after the syntax tree is obtained by parsing the query statement by the parser, the execution unit 403 is configured to obtain, based on a first preset event tracker in the parser, a first syntax tree obtained by syntax parsing the query statement by the parser; and/or obtain, based on a second preset event tracker in the parser, a second syntax tree obtained by semantic optimizing the first syntax tree by the parser.

In one or more embodiments of the present disclosure, to generate the syntax tree serialization result based on the syntax tree, the serialization unit 404 is configured to traverse nodes in the syntax tree, and generate structural body of a preset data structure corresponding to each of the nodes in sequence, to obtain a tree structure corresponding to the syntax tree and based on the structural body, where the structural body of the preset data structure comprises a node type, property information, and sub-node information; and transform the tree structure into a character string to obtain the syntax tree serialization result.

In one or more embodiments of the present disclosure, to traverse the nodes in the syntax tree, and generate the structural body of the preset data structure corresponding to each of the nodes in sequence, to obtain the tree structure corresponding to the syntax tree and based on the structural body, the serialization unit 404 is configured to traverse the nodes in the syntax tree, call preset functions in sequence, to extract the corresponding node type, the property information, and the sub-node information corresponding to each of the nodes, and add the node type, the property information, and the sub-node information corresponding to each of the nodes into one preset data structure to generate the structural body of the corresponding preset data structure.

In one or more embodiments of the present disclosure, to generate the syntax tree serialization result based on the syntax tree, as the parsing result of the query statement to be output, the serialization unit 404 is configured to store, after generating the syntax tree serialization result, the syntax tree serialization result into an optimizer trace table corresponding to the query statement; display, in response to a view instruction for the optimizer trace table, the optimizer trace table corresponding to the query statement; and obtain the syntax tree serialization result from the optimizer trace table corresponding to the query statement, and output the syntax tree serialization result.

In one or more embodiments of the present disclosure, the execution unit 403 is further configured to enable a function of recording an optimizer trace table before executing the query statement in the empty database table.

In one or more embodiments of the present disclosure, to creat the empty database table corresponding to the database table to be queried, the creation unit 402 is configured to create the empty database table corresponding to the database table to be queried in a preset database instance. The preset database instance and a database instance in which the database table to be queried is located are different database instances.

The device provided in this embodiment can be configured to implement the technical solutions of the method embodiments described above, and an implementation principle and technical effects thereof are similar to those of the method embodiments, and will not be described in detail in this embodiment.

Further, referring to FIG. 5, a schematic structural diagram of an electronic device 500 suitable for implementing the embodiments of the present disclosure is shown. The electronic device 500 can be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal); and a fixed terminal such as a digital TV and a desktop computer. The electronic device shown in FIG. 5 is merely an example, and shall not impose any limitation on the function and scope of use of the embodiments of the present disclosure.

As shown in FIG. 5, the electronic device 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to a bus 504.

Usually, following apparatuses can be connected to the I/O interface 505: an input apparatus 506 including a touch screen, a touchpad, a keyboard, a mouse, a camera, a microphone, an accelerometer, a gyroscope, and the like; an output apparatus 507 including a Liquid Crystal Display (LCD), a speaker, a vibrator, and the like; a storage apparatus 508 including a magnetic tape, a hard disk drive, and the like; and a communication apparatus 509. The communication apparatus 509 can allow the electronic device 500 to wirelessly or wiredly communicate with other devices to exchange data. Although FIG. 5 shows the electronic device 500 with multiple apparatuses, it should be understood that the electronic device 500 is not required to implement or have all the apparatuses shown, and can alternatively implement or have more or fewer apparatuses.

Particularly, according to the embodiments of the present application, the process described in the reference flowchart above can be implemented as a computer software program. For example, the embodiments of the present disclosure include a computer program product, including a computer program carried on a computer-readable medium, and the computer program includes program codes used for performing the methods shown in the flowcharts. In such an embodiment, the computer program may be downloaded and installed from a network through the communication apparatus 509, or installed from the storage apparatus 508, or installed from the ROM 502. When the computer program is executed by the processing apparatus 501, the above-mentioned functions defined in the methods of the embodiments of the present application are executed.

It should be noted that the computer-readable medium mentioned in the present application can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard disk drive, a RAM, a ROM, an Erasable Programmable Read Only Memory (EPROM) or flash memory, an optical fiber, a Compact Disc Read-Only Memory (CD-ROM), an optical storage device, a magnetic storage device, or any suitable combination of the above. In the present application, the computer-readable storage medium may be any tangible medium that contains or stores a program, and the program can be used by or in combination with an instruction execution system, apparatus, or device. In the present application, the computer-readable signal media may include data signals propagated in a baseband or as part of a carrier wave, which carries computer-readable program codes. The propagated data signal may be in various forms, including but not limited to an electromagnetic signal, an optical signal, or any suitable combination thereof. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but are not limited to: a wire, an optical cable, a Radio Frequency (RF), and the like, or any suitable combination of the above.

The computer-readable medium may be included in the electronic device or exist alone and is not assembled into the electronic device.

The above computer-readable medium carries one or more programs. When executed by the electronic device, the one or more programs cause the electronic device to implement the methods shown in the above embodiments.

Computer program codes for performing the operations of the present disclosure may be written in one or more programming languages or a combination thereof. The above programming languages include an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case that a remote computer is involved, the remote computer can be connected to a user computer through any kind of networks, including a LAN or a WAN, or can be connected to an external computer (e.g., through an Internet using an Internet service provider).

The flowcharts and block diagrams in the accompanying drawings illustrate possible system architectures, functions, and operations that may be implemented by a system, a method, and a computer program product according to various embodiments of the present application. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present application can be implemented through software or hardware. The name of the unit does not constitute a limitation on the unit itself. For example, the first obtaining unit can also be described as “a unit that obtains at least two Internet protocol addresses”.

The functions described herein above may be performed, at least in part, by one or a plurality of hardware logic components. For example, nonrestrictively, example hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), and the like.

In the context of the present application, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

In a first aspect, according to one or more embodiments of the present disclosure, a method for parsing a database query statement is provided, and the method includes: obtaining a query statement for a database table to be queried, and creating an empty database table corresponding to the database table to be queried, the empty database table and the database table to be queried having a same structure; executing the query statement in the empty database table, calling a parser installed in a database to parse the query statement to obtain a syntax tree, and generating an execution plan based on the syntax tree for execution in the empty database table; and obtaining the syntax tree from the parser in an execution process of the query statement, and generating a syntax tree serialization result based on the syntax tree, as a parsing result of the query statement to be output.

According to one or more embodiments of the present disclosure, obtaining the syntax tree from the parser in the execution process of the query statement includes: obtaining, based on the preset event tracker in the parser, the syntax tree after the syntax tree is obtained by parsing the query statement by the parser.

According to one or more embodiments of the present disclosure, obtaining, based on the preset event tracker in the parser, the syntax tree after the syntax tree is obtained by parsing the query statement by the parser includes: obtaining, based on a first preset event tracker in the parser, a first syntax tree obtained by syntax parsing the query statement by the parser; and/or obtaining, based on a second preset event tracker in the parser, a second syntax tree obtained by semantic optimizing the first syntax tree by the parser.

According to one or more embodiments of the present disclosure, generating the syntax tree serialization result based on the syntax tree includes: traversing nodes in the syntax tree, and generating structural body of a preset data structure corresponding to each of the nodes in sequence, to obtain a tree structure corresponding to the syntax tree and based on the structural body, where the structural body of the preset data structure comprises a node type, property information, and sub-node information; and transforming the tree structure into a character string to obtain the syntax tree serialization result.

According to one or more embodiments of the present disclosure, traversing the nodes in the syntax tree, and generating the structural body of the preset data structure corresponding to each of the nodes in sequence, to obtain the tree structure corresponding to the syntax tree and based on the structural body includes: traversing the nodes in the syntax tree, calling preset functions in sequence, to extract the corresponding node type, the property information, and the sub-node information corresponding to each of the nodes, and adding the node type, the property information, and the sub-node information corresponding to each of the nodes into one preset data structure to generate the structural body of the corresponding preset data structure.

According to one or more embodiments of the present disclosure, generating the syntax tree serialization result based on the syntax tree, as the parsing result of the query statement to be output includes: storing, after generating the syntax tree serialization result, the syntax tree serialization result into an optimizer trace table corresponding to the query statement; displaying, in response to a view instruction for the optimizer trace table, the optimizer trace table corresponding to the query statement; and obtaining the syntax tree serialization result from the optimizer trace table corresponding to the query statement, and outputting the syntax tree serialization result.

According to one or more embodiments of the present disclosure, the method further includes: enabling a function of recording an optimizer trace table before executing the query statement in the empty database table.

According to one or more embodiments of the present disclosure, creating the empty database table corresponding to the database table to be queried includes: creating the empty database table corresponding to the database table to be queried in a preset database instance, where the preset database instance and a database instance in which the database table to be queried is located are different database instances.

In a second aspect, according to one or more embodiments of the present disclosure, a device for parsing a database query statement is provided, and the device includes: an obtaining unit configured to obtain a query statement for a database table to be queried; a creation unit configured to create an empty database table corresponding to the database table to be queried, the empty database table and the database table to be queried having a same structure; an execution unit configured to execute the query statement in the empty database table, call a parser installed in a database to parse the query statement to obtain a syntax tree, and generate an execution plan based on the syntax tree for execution in the empty database table; and a serialization unit configured to obtain the syntax tree from the parser in an execution process of the query statement, and generate a syntax tree serialization result based on the syntax tree, as a parsing result of the query statement to be output.

According to one or more embodiments of the present disclosure, to obtain the syntax tree from the parser in the execution process of the query statement, the execution unit is configured to obtain, based on the preset event tracker in the parser, the syntax tree after the syntax tree is obtained by parsing the query statement by the parser.

According to one or more embodiments of the present disclosure, to obtain, based on the preset event tracker in the parser, the syntax tree after the syntax tree is obtained by parsing the query statement by the parser, the execution unit is configured to obtain, based on a first preset event tracker in the parser, a first syntax tree obtained by syntax parsing the query statement by the parser; and/or obtain, based on a second preset event tracker in the parser, a second syntax tree obtained by semantic optimizing the first syntax tree by the parser.

According to one or more embodiments of the present disclosure, to generate the syntax tree serialization result based on the syntax tree, the serialization unit is configured to traverse nodes in the syntax tree, and generate structural body of a preset data structure corresponding to each of the nodes in sequence, to obtain a tree structure corresponding to the syntax tree and based on the structural body, where the structural body of the preset data structure comprises a node type, property information, and sub-node information; and transform the tree structure into a character string to obtain the syntax tree serialization result.

According to one or more embodiments of the present disclosure, to traverse the nodes in the syntax tree, and generate the structural body of the preset data structure corresponding to each of the nodes in sequence, to obtain the tree structure corresponding to the syntax tree and based on the structural body, the serialization unit is configured to traverse the nodes in the syntax tree, call preset functions in sequence, to extract the corresponding node type, property information, and sub-node information corresponding to each of the nodes, and add the node type, the property information, and the sub-node information corresponding to each of the nodes into one preset data structure to generate the structural body of the corresponding preset data structure.

According to one or more embodiments of the present disclosure, to generate the syntax tree serialization result based on the syntax tree, as the parsing result of the query statement to be output, the serialization unit is configured to store, after generating the syntax tree serialization result, the syntax tree serialization result into an optimizer trace table corresponding to the query statement; display, in response to a view instruction for the optimizer trace table, the optimizer trace table corresponding to the query statement; and obtain the syntax tree serialization result from the optimizer trace table corresponding to the query statement, and output the syntax tree serialization result.

According to one or more embodiments of the present disclosure, the execution unit is further configured to enable a function of recording an optimizer trace table before executing the query statement in the empty database table.

According to one or more embodiments of the present disclosure, to create the empty database table corresponding to the database table to be queried, the creation unit is configured to create the empty database table corresponding to the database table to be queried in a preset database instance, where the preset database instance and a database instance in which the database table to be queried is located are different database instances.

In a third aspect, according to one or more embodiments of the present disclosure, an electronic device is provided, and the electronic device includes: at least one processor and a memory. The memory stores computer-executable instructions; and the at least one processor is configured to execute the computer-executable instructions stored in the memory to cause the at least one processor to perform the method for parsing the database query statement in the first aspect and in various possible designs of the first aspect.

In a fourth aspect, according to one or more embodiments of the present disclosure, a computer-readable storage medium is provided. The computer-readable storage medium stores computer-executable instructions which, when executed by a processor, implement the method for parsing the database query statement in the first aspect and in various possible designs of the first aspect.

In a fifth aspect, according to one or more embodiments of the present disclosure, a computer program product is provided. The computer program includes computer-executable instructions which, when executed by a processor, implement the method for parsing the database query statement in the first aspect and in various possible designs of the first aspect.

The foregoing descriptions are merely preferred embodiments of the present disclosure and explanations of the applied technical principles. Those skilled in the art should understand that the scope of disclosure referred to in the present disclosure is not limited to the technical solutions formed by specific combinations of the aforementioned technical features, but also covers other technical solutions formed by any combinations of the aforementioned technical features or their equivalent features without departing from the concept of the above disclosure, for example, a technical solution formed by replacing the above features with (but not limited to) technical features with similar functions disclosed in the present disclosure.

In addition, although various operations are depicted in a specific order, this should not be understood as requiring these operations to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features that are described in the context of the single embodiment may also be implemented in a plurality of embodiments separately or in any suitable sub-combinations.

Although the subject matter has been described in a language specific to structural features and/or method logical actions, it should be understood that the subject matter limited in the attached claims may not necessarily be limited to the specific features or actions described above. On the contrary, the specific features and actions described above are only exemplary forms for implementing the claims.

I/We claim:

1. A method for parsing a database query statement, comprising:
obtaining a query statement for a database table to be queried, and creating an empty database table corresponding to the database table to be queried, the empty database table and the database table to be queried having a same structure;
executing the query statement in the empty database table, calling a parser installed in a database to parse the query statement to obtain a syntax tree, and generating an execution plan based on the syntax tree for execution in the empty database table; and
obtaining the syntax tree from the parser in an execution process of the query statement, and generating a syntax tree serialization result based on the syntax tree, as a parsing result of the query statement to be output.

2. The method of claim 1, wherein obtaining the syntax tree from the parser in the execution process of the query statement comprises:
obtaining, based on a preset event tracker in the parser, the syntax tree after the syntax tree is obtained by parsing the query statement by the parser.

3. The method of claim 2, wherein obtaining, based on the preset event tracker in the parser, the syntax tree after the syntax tree is obtained by parsing the query statement by the parser comprises:
obtaining, based on a first preset event tracker in the parser, a first syntax tree obtained by syntax parsing the query statement by the parser; and/or
obtaining, based on a second preset event tracker in the parser, a second syntax tree obtained by semantic optimizing the first syntax tree by the parser.

4. The method of claim 1, wherein generating the syntax tree serialization result based on the syntax tree comprises:
traversing nodes in the syntax tree, and generating a structural body of a preset data structure corresponding to each of the nodes in sequence, to obtain a tree structure corresponding to the syntax tree and based on the structural body, wherein the structural body of the preset data structure comprises a node type, property information, and sub-node information; and
transforming the tree structure into a character string to obtain the syntax tree serialization result.

5. The method of claim 4, wherein traversing the nodes in the syntax tree, and generating the structural body of the preset data structure corresponding to each of the nodes in sequence, to obtain the tree structure corresponding to the syntax tree and based on the structural body comprise:
traversing the nodes in the syntax tree, calling preset functions in sequence to extract the node type, the property information, and the sub-node information corresponding to each of the nodes, and adding the node type, the property information, and the sub-node information corresponding to each of the nodes into one preset data structure to generate the structural body of the corresponding preset data structure.

6. The method of claim 1, wherein generating the syntax tree serialization result based on the syntax tree, as the parsing result of the query statement to be output comprises:
storing, after generating the syntax tree serialization result, the syntax tree serialization result into an optimizer trace table corresponding to the query statement;
displaying, in response to a view instruction for the optimizer trace table, the optimizer trace table corresponding to the query statement; and
obtaining the syntax tree serialization result from the optimizer trace table corresponding to the query statement, and outputting the syntax tree serialization result.

7. The method of claim 1, wherein creating the empty database table corresponding to the database table to be queried comprises:
creating the empty database table corresponding to the database table to be queried in a preset database instance, wherein the preset database instance and a database instance in which the database table to be queried is located are different database instances.

8. An electronic device, comprising at least one processor and a memory, wherein
the memory stores computer-executable instructions, and
the at least one processor is configured to execute the computer-executable instructions stored in the memory to:
obtain a query statement for a database table to be queried, and create an empty database table corresponding to the database table to be queried, the empty database table and the database table to be queried having a same structure;
execute the query statement in the empty database table, calli a parser installed in a database to parse the query statement to obtain a syntax tree, and generate an execution plan based on the syntax tree for execution in the empty database table; and
obtain the syntax tree from the parser in an execution process of the query statement, and generate a syntax tree serialization result based on the syntax tree, as a parsing result of the query statement to be output.

9. The electronic device of claim 8, wherein to obtain the syntax tree from the parser in the execution process of the query statement, the at least one processor is configured to:
obtain, based on a preset event tracker in the parser, the syntax tree after the syntax tree is obtained by parsing the query statement by the parser.

10. The electronic device of claim 9, wherein to obtain, based on the preset event tracker in the parser, the syntax tree after the syntax tree is obtained by parsing the query statement by the parser, the at least one processor is configured to:
obtain, based on a first preset event tracker in the parser, a first syntax tree obtained by syntax parsing the query statement by the parser; and/or
obtain, based on a second preset event tracker in the parser, a second syntax tree obtained by semantic optimizing the first syntax tree by the parser.

11. The electronic device of claim 8, wherein to generate the syntax tree serialization result based on the syntax tree, the at least one processor is configured to:
travers nodes in the syntax tree, and generate a structural body of a preset data structure corresponding to each of the nodes in sequence, to obtain a tree structure corresponding to the syntax tree and based on the structural body, wherein the structural body of the preset data structure comprises a node type, property information, and sub-node information; and
transform the tree structure into a character string to obtain the syntax tree serialization result.

12. The electronic device of claim 11, wherein to traverse the nodes in the syntax tree, and generate the structural body of the preset data structure corresponding to each of the nodes in sequence, to obtain the tree structure corresponding to the syntax tree and based on the structural body, the at least one processor is configured to:
traverse the nodes in the syntax tree, call preset functions in sequence to extract the node type, the property information, and the sub-node information corresponding to each of the nodes, and add the node type, the property information, and the sub-node information corresponding to each of the nodes into one preset data structure to generate the structural body of the corresponding preset data structure.

13. The electronic device of claim 8, wherein to generate the syntax tree serialization result based on the syntax tree, as the parsing result of the query statement to be output, the at least one processor is configured to:
store, after generating the syntax tree serialization result, the syntax tree serialization result into an optimizer trace table corresponding to the query statement;
display, in response to a view instruction for the optimizer trace table, the optimizer trace table corresponding to the query statement; and
obtain the syntax tree serialization result from the optimizer trace table corresponding to the query statement, and outputting the syntax tree serialization result.

14. The electronic device of claim 8, wherein to create the empty database table corresponding to the database table to be queried, the at least one processor is configured to:
create the empty database table corresponding to the database table to be queried in a preset database instance, wherein the preset database instance and a database instance in which the database table to be queried is located are different database instances.

15. A non-transitory computer-readable storage medium storing computer-executable instructions which, when executed by a processor, configure the processor to:
obtain a query statement for a database table to be queried, and create an empty database table corresponding to the database table to be queried, the empty database table and the database table to be queried having a same structure;
execute the query statement in the empty database table, call a parser installed in a database to parse the query statement to obtain a syntax tree, and generate an execution plan based on the syntax tree for execution in the empty database table; and
obtain the syntax tree from the parser in an execution process of the query statement, and generate a syntax tree serialization result based on the syntax tree, as a parsing result of the query statement to be output.

16. The non-transitory computer-readable storage medium of claim 15, wherein to obtain the syntax tree from the parser in the execution process of the query statement, the processor is configured to:
obtain, based on a preset event tracker in the parser, the syntax tree after the syntax tree is obtained by parsing the query statement by the parser.

17. The non-transitory computer-readable storage medium of claim 16, wherein to obtain, based on the preset event tracker in the parser, the syntax tree after the syntax tree is obtained by parsing the query statement by the parser, the processor is configured to:
obtain, based on a first preset event tracker in the parser, a first syntax tree obtained by syntax parsing the query statement by the parser; and/or
obtain, based on a second preset event tracker in the parser, a second syntax tree obtained by semantic optimizing the first syntax tree by the parser.

18. The non-transitory computer-readable storage medium of claim 15, wherein to generate the syntax tree serialization result based on the syntax tree, the processor is configured to:
traverse nodes in the syntax tree, and generate a structural body of a preset data structure corresponding to each of the nodes in sequence, to obtain a tree structure corresponding to the syntax tree and based on the structural body, wherein the structural body of the preset data structure comprises a node type, property information, and sub-node information; and
transform the tree structure into a character string to obtain the syntax tree serialization result.

19. The non-transitory computer-readable storage medium of claim 18, wherein to traverse the nodes in the syntax tree, and generate the structural body of the preset data structure corresponding to each of the nodes in sequence, to obtain the tree structure corresponding to the syntax tree and based on the structural body, the processor is configured to:
traverse the nodes in the syntax tree, call preset functions in sequence to extract the node type, the property information, and the sub-node information corresponding to each of the nodes, and add the node type, the property information, and the sub-node information corresponding to each of the nodes into one preset data structure to generate the structural body of the corresponding preset data structure.

20. The non-transitory computer-readable storage medium of claim 15, wherein to generate the syntax tree serialization result based on the syntax tree, as the parsing result of the query statement to be output, the processor is configured to:
store, after generating the syntax tree serialization result, the syntax tree serialization result into an optimizer trace table corresponding to the query statement;
display, in response to a view instruction for the optimizer trace table, the optimizer trace table corresponding to the query statement; and
obtain the syntax tree serialization result from the optimizer trace table corresponding to the query statement, and output the syntax tree serialization result.
